(19) United States
(12) Patent Application Publication
(10) Pub. No.: US 2004/0086750 A1
(43) Pub. Date: May 6, 2004

(54) Antiferromagnetic layer system and methods for magnectically storing data in anti-ferromagnetic layer system of the like

(76) Inventors: Oliver De Haas, Dresden (DE); Rudolf Schäfer, Dresden (DE); Claus Schneider, Dresden (DE)

Correspondence Address: GREENBLUM & BERNSTEIN, P.L.C., 1950 ROLAND CLARKE PLACE, RESTON, VA, 20191, US

(21) Appl. No.: 10/473,591

(22) PCT Filed: Apr. 5, 2002
(86) PCT No.: PCT/DE02/01301

(30) Foreign Application Priority Data
Apr. 12, 2001 (DE) 101193807

(51) Int. Cl. B32B 9/00

(52) U.S. Cl. 428/692

(57) ABSTRACT

The invention is used in the field of materials engineering and relates to antiferromagnetic layer systems and methods for magnetically storing data, which can be used, for example, in computer hard disks. The object of the invention is to disclose an antiferromagnetic layer system and methods with the aid of which a specific writing and reading of information is possible in such antiferromagnetic layer systems. The object is attained through an antiferromagnetic layer system, comprising at least one ferromagnetic and at least one antiferromagnetic layer, whereby the Curie temperature of the ferromagnetic layer material is greater than the blocking temperature of the antiferromagnetic layer material and in which the ferromagnetic and antiferromagnetic layer(s) are coupled to one another at least with regard to their magnetization configuration by means of exchange anisotropy effects, and in which the layer thickness of the antiferromagnetic layer(s) is a function of the operating temperature of the employed antiferromagnetic layer system, whereby the layer thicknesses likewise increase with increasing operating temperatures.

### FIELD OF APPLICATION OF THE INVENTION

The invention is used in the field of materials engineering and relates to antiferromagnetic layer systems and methods for magnetic data storage in such antiferromagnetic layer systems that can be used, e.g., in computer hard disks or in other magnetic mass storage systems.

### PRIOR ART

Granular hard magnetic materials such as, e.g., sputtered cobalt platinum layers and layer systems have hitherto been used as a storage medium for magnetically storing data. The storage information is available in the form of the magnetic structure, whereby one magnetic domain extends over several grains. A transition between two oppositely magnetized areas represents one storage unit (a bit). The information is entered by means of local magnetic fields and can thus be accidentally changed or deleted by strong external fields. The functionality of these conventional storage disks is described in patents U.S. Pat. No. 4,789,598 and U.S. Pat. No. 5,523,173.

An annual increase in the bit density of approx. 30% and more has been achieved in recent years through the further development of the magnetic materials and components. The increase in the bit density reduces the area available to the storage unit in an inversely proportional manner. Adjacent domain transitions thus move closer together. However, their stray field, which is also used for the read-out of the information via magneto-resistive read heads, destabilizes the magnetization of the individual domains. At the same time, as the magnetic areas are reduced in size, their susceptibility to thermal fluctuations and magnetic reversal processes caused thereby increases. The latter is also known as the “superparamagnetic limit.” In order to magnetize smaller areas in a stable manner nevertheless, the magnetic anisotropy of the magnetic grains must be increased or their magnetization and thus the stray field must be reduced. Both methods of writing information lead to an increase in the coercive force, which is necessary in order to reverse the magnetic poles of an area. The magnetic field that can be produced by the write head is limited by the saturation magnetization of the yoke material. Due to the restrictions mentioned, the magnetic bit density has an upper limit of approx. 100 Gbit/inch\hat{ }2 (15.5 Gbit/cm\hat{ }2).

In contrast to ferromagnets, in antiferromagnetic materials, adjacent atomic moments are aligned in an antiparallel-not a parallel-manner. They therefore have a vanishing average magnetization. When the two magnetic sublattices aligned in an antiparallel manner (only the atoms, the spins of which have the same orientation) are observed, the sublattice magnetizations prefer to take certain directions. Like the ferromagnets, antiferromagnets in general have a uniaxial or multi-axial anisotropy. Because of the vanishing overall moment, antiferromagnets do not interact with external magnetic fields as long as the antiparallel alignment of the sublattices is not broken up.

Due to the intrinsic magnetic properties of an antiferromagnet, it can be used as a storage medium. The sublattice magnetizations of the antiferromagnets are not responsive to magnetic fields as they occur in technical equipment. Entered data would therefore be immune to interference fields. In addition, the transition area between two domains can be kept very narrow, since transitions between opposed sublattice magnetizations on the atomic scale are possible in the antiferromagnet. Due to the vanishing average magnetization, antiferromagnetic domains do not produce stray fields. Demagnetization effects are therefore not to be expected either. Antiferromagnets therefore meet the prerequisite for a clear increase in the bit density compared with conventional ferromagnetic layers. However, until now it has not been possible to enter information in the antiferromagnets in a targeted manner. Likewise, no method is yet known for the read-out of information from antiferromagnets.

### PRESENTATION OF THE INVENTION

The object of the invention is to disclose an antiferromagnetic layer system and methods with the aid of which a targeted writing and reading of information in such antiferromagnetic layer systems is possible.

The object is attained through the invention disclosed in the claims. Further developments are the subject matter of the subclaims.

The antiferromagnetic layer system according to the invention comprises at least one ferromagnetic and at least one antiferromagnetic layer, whereby the Curie temperature of the ferromagnetic layer material is greater than the blocking temperature of the layer system. The ferromagnetic and antiferromagnetic layer(s) are thereby coupled to one another through exchange anisotropy effects, at least with regard to their magnetization configuration. Using the temperature-dependence of the reactive effect of the ferromagnetic layer on the antiferromagnetic layer, the temperature-dependence of the stability of the magnetization configuration can be controlled through the selection of the thickness of the antiferromagnetic layer. The layer thicknesses of the antiferromagnetic layer(s) are thus a function of the operating temperature of the antiferromagnetic layer system used, whereby the layer thicknesses also increase with increasing operating temperature.

In this manner it is possible to store a datum that is stable with respect to high magnetic fields at operating temperature and to achieve the writing and reading of data in the antiferromagnetic layer(s) through the controlled increase in temperature in advantageously relatively small areas.

It is advantageous if the ferromagnetic and antiferromagnetic layer(s) are not in direct contact or only partially in direct contact, whereby in any case a magnetic interaction between the layers is realized.

It is also advantageous if a non-magnetic intermediate layer is arranged between at least one of the ferromagnetic and antiferromagnetic layers, whereby the magnetic interaction between the ferromagnetic and the antiferromagnetic layer must not be materially obstructed by the non-magnetic intermediate layer.

The non-magnetic intermediate layers advantageously have layer thicknesses of between 0.2 and 2.0 nm.

Likewise advantageously, the layer systems are extended and/or structured.

Also advantageously NiFe (permalloy) is used as a ferromagnetic layer material.

Furthermore, it is advantageous if NiO, IrMn and/or FeMn are used as an antiferromagnetic layer material.

It is also advantageous if layer thicknesses of the antiferromagnetic layer between 1 and 20 nm are present at operating temperatures between 0 and 150° C.

It is likewise advantageous if the layers have lateral dimensions in the micro and/or nano range.

With the method according to the invention for magnetically storing data in antiferromagnetic layer systems, at least one layer system is produced from at least one ferromagnetic layer and from at least one antiferromagnetic layer. The ferromagnetic layer material used thereby features a Curie temperature greater than the blocking temperature of the antiferromagnetic layer material used. The at least one antiferromagnetic layer of the layer system is subjected to a single-stage or multi-stage local heat treatment at a temperature greater than the blocking temperature of the antiferromagnetic layer material and lower than the Curie temperature of the ferromagnetic layer material, and subsequently the cooling is carried out in the presence of a global or local directional magnetic field.

The local heat treatment is advantageously carried out by means of a laser, a near-field optical system or a conductive scanning probe tip.

Likewise advantageously, reading the stored data is carried out via magneto-optic or magneto-resistive processes.

If an antiferromagnetic layer and a ferromagnetic layer are brought into contact, they are coupled at least with regard to their magnetization configuration by means of exchange anisotropy effects. Depending on the balance of the stabilities (anisotropies) of the ferromagnetic and antiferromagnetic layer, a magnetization configuration forms in the antiferromagnetic layer, which configuration follows that of the ferromagnetic layer, or a magnetization configuration in the ferromagnetic layer, which configuration follows that of the antiferromagnetic layer. By raising the temperature higher than the blocking temperature, the stability of the magnetization configuration of the antiferromagnetic layer is weakened so much that it adopts the magnetization configuration of the ferromagnetic layer and retains it during cooling to below the blocking temperature.

With the further method according to the invention for magnetically storing data in antiferromagnetic layer systems, the antiferromagnetic layer system used is used at an operating temperature greater than the blocking temperature of the antiferromagnetic layer. The magnetization configuration of the ferromagnetic component is locally stored in the antiferromagnetic layer via a ferromagnetic component by means of exchange coupling, and/or the magnetization configuration of the antiferromagnetic layer is read from the ferromagnetic component. For storing the data, a magnetic field is thereby applied and reading the data is carried out without the application of a magnetic field.

### THE BEST WAY TO CARRY OUT THE INVENTION

The invention is described in more detail below on the basis of several exemplary embodiments. Thereby

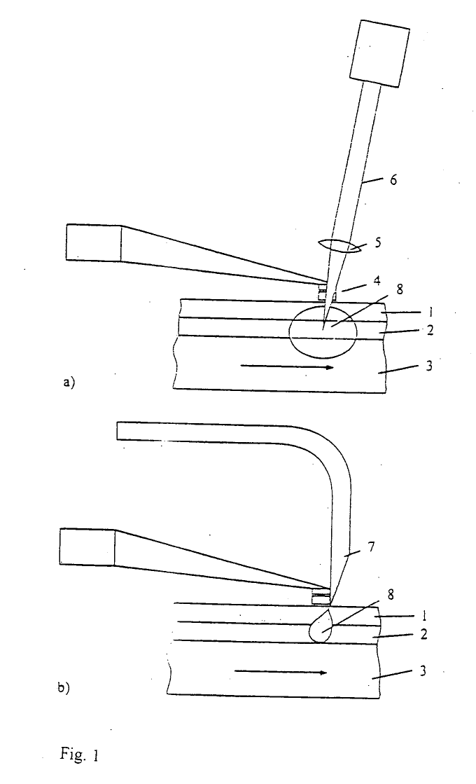

FIG. 1 Shows the structure of a data storage unit from the layer system according to the invention using components for increasing the temperature locally, and

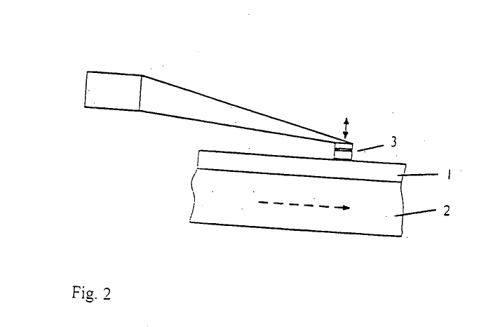

FIG. 2 Shows the structure of a data storage unit from the layer system according to the invention using a magnetic component for storing the data.

### Example 1

A layer system, comprising 12 nm NiO, 10 nm Ni₈₁Fe₁₉ and 2 nm Ta as an oxidation barrier is applied by means of cathode sputtering at 20° C. in an areal manner onto a circular disk that is used as base material 3. A rotationally symmetrical magnetic field of a force 1 kA/cm is present during the layer deposition. The blocking temperature of the layer system thus produced is approx. 70° C. The disk 3 rotates under a moveable write/read head 4 during operation. The antiferromagnetic layer 2 cannot be influenced by magnetic fields up to 0.5 T in the temperature range of 0° C. through 70° C., the operating temperature. Through the coupling of a high-energy light spot in the rotational direction directly in front of the write/read head 4, the layer system can be heated to temperatures of >85°. The size of the heated area 8 depends on the size of the light spot. A light spot of 300 nm diameter is achieved through a focused laser beam 6 or the light is concentrated on an area of a few tens of nm through a near-field optical system 7 (pointed fiber optic cable).

Through exceeding the blocking temperature locally, the magnetization generated in the ferromagnetic layer 1 by the write head 4 is transferred to the magnetization configuration of the antiferromagnetic layer 2. Since the disk 3 moves under the light spot and the write/read head 4, the area described cools down again immediately after the write process to below the blocking temperature of 70° C., so that the entered information is stable with regard to external fields. The stray field of the ferromagnetic Ni₈₁Fe₁₉ layer is used to read out the written information, which stray field is measured by a magneto-resistive read head 4.

### Example 2

An 8 nm-thick NiO layer is applied in an areal manner by means of cathode sputtering at 20° C. onto a circular disk 3 that is used as base material. A rotationally symmetrical magnetic field of a force 1 kA/cm is present during the layer deposition. The disk 3 moves under a likewise moveable write/read head 4 during operation. The write/read head 4 comprises a layer system NiFe (1 nm) Cu (0.8 nm) Co (10 nm) and a magnetic yoke that is surrounded by a current coil and in the opening of which the layer system is located. For writing, the write/read head 4 is brought closer to the storage disk 3 until the magnetic coupling between the antiferromagnetic NiO layer 2 and the 1 nm-thick Ni₈₁Fe₁₉ layer 1 of the read head 4 is produced. A magnetization is imposed on the Ni₈₁Fe₁₉ 1 layer through a current in the current coil, which magnetization is taken over by the antiferromagnetic layer 2 through the exchange anisotropy. For the read-out of the information, the write/read head 4 is brought closer to the storage disk 3 in the same way as for writing. However, no current flows through the coil, so that the thus free Ni₈₁Fel₉ layer 1 is aligned corresponding to the exchange anisotropy of the antiferromagnetic NiO layer 2.

List of Reference Numbers

| | |
|---|---|
| 1 | Ferromagnetic layer |
| 2 | Antiferromagnetic layer |
| 3 | Base layer |
| 4 | Write/read head |
| 5 | Convergent lens |
| 6 | Laser beam |
| 7 | Near-field optical system |
| 8 | Heated area |

1. Antiferromagnetic layer system, comprising at least one ferromagnetic (1) and at least one antiferromagnetic (2) layer, whereby the Curie temperature of the ferromagnetic layer material (1) is greater than the blocking temperature of the antiferromagnetic layer material (2), and in which the ferromagnetic (1) and antiferromagnetic (2) layer(s) are coupled to one another at least with regard to their magnetization configuration by means of exchange anisotropy effects, and in which the layer thickness of the antiferromagnetic layer(s) (2) is a function of the operating temperature of the employed antiferromagnetic layer system (2), whereby the layer thicknesses likewise increase with increasing operating temperatures.

2. Antiferromagnetic layer system according to claim 1, in which the ferromagnetic (1) and antiferromagnetic (2) layer(s) are not in direct contact or only partially in direct contact, whereby in any case a magnetic interaction between the layers is realized.

3. Antiferromagnetic layer system according to claim 2, in which a non-magnetic intermediate layer is arranged between at least one of the ferromagnetic (1) and antiferromagnetic (2) layers, whereby the magnetic interaction between the ferromagnetic (1) and the antiferromagnetic (2) layer must not be materially obstructed by the non-magnetic intermediate layer.

4. Antiferromagnetic layer system according to claim 3, in which the non-magnetic intermediate layers have layer thicknesses of between 0.2 and 2.0 nm.

5. Antiferromagnetic layer system according to claim 1, in which the layer systems are extended and/or structured.

6. Antiferromagnetic layer system according to claim 1, in which NiFe (permalloy) is used as a ferromagnetic (1) layer material.

7. Antiferromagnetic layer system according to claim 1, in which NiO, IrMn and/or FeMn are used as antiferromagnetic (2) layer material.

8. Antiferromagnetic layer system according to claim 1, in which layer thicknesses of the antiferromagnetic layer (2) of between 1 and 20 nm are realized at operating temperatures between 0 and 150° C.

9. Antiferromagnetic layer system according to claim 1, in which the layers have lateral dimensions in the micro and/or nano range.

10. Method for magnetically storing data in antiferromagnetic layer systems according to at least one of claims 1 through 9, in which at least one layer system comprising at least one ferromagnetic layer (1) and at least one antiferromagnetic layer (2) is produced, whereby the ferromagnetic layer material (1) used has a Curie temperature greater than the blocking temperature of the antiferromagnetic layer material (2) used, and the at least one antiferromagnetic layer (2) of the layer system is subjected to a single-stage or multi-stage local heat treatment at a temperature greater than the blocking temperature of the antiferromagnetic layer material (2) and lower than the Curie temperature of the ferromagnetic layer material (1), and subsequently the cooling is carried out in the presence of a global or local directional magnetic field.

11. Method according to claim 10, in which the local heat treatment is carried out by means of a laser (6), a near-field optical system (7) or a conductive scanning probe tip.

12. Method according to claim 10, in which reading the stored data is carried out via magneto-optic or magneto-resistive processes.

13. Method for magnetically storing data in antiferromagnetic layer systems according to at least one of claims 1 through 9, in which the antiferromagnetic layer system (2) used is used at an operating temperature greater than the blocking temperature of the antiferromagnetic layer (2) and the magnetization configuration of the ferromagnetic component (4) is locally stored in the antiferromagnetic layer (2) via a ferromagnetic component (4) by means of exchange coupling, and/or the magnetization configuration of the antiferromagnetic layer (2) is read from the ferromagnetic component (4), whereby for storing the data, a magnetic field is applied and reading the data is carried out without the application of a magnetic field.
